(19) United States
(12) Patent Application Publication
(10) Pub. No.: US 2025/0060215 A1
(43) Pub. Date: Feb. 20, 2025

(54) A DEVICE FOR INDICATING ORIENTATION OF AN OBJECT

(71) Applicant: Tilak SRINIVASAN, Bangalore, Karnataka (IN)

(72) Inventor: Tilak SRINIVASAN, Bangalore, Karnataka (IN)

(21) Appl. No.: 18/723,550

(22) PCT Filed: Jan. 4, 2023
(86) PCT No.: PCT/IB2023/050047

§ 371 Date: Jun. 24, 2024

(30) Foreign Application Priority Data
Jan. 4, 2022 (IN) 202241000329

(51) Int. Cl. G01C 9/10; G01C 9/06

(52) U.S. Cl. CPC G01C 9/10; G01C 2009/066; G01C 2009/107

(57) ABSTRACT

Present disclosure discloses a device (100) for indicating orientation of an object (P). The device (100) includes a housing (14) positioned on the object (P). The housing includes a first and a second light source (LS1, LS2) positioned opposite to a first screen (S1) and a second screen (S2). Further, an enclosure (8) disposed within the housing (14) and a rod structure (101) rotatably disposed within the enclosure (8). The rod structure (101) includes a plurality of rods fixed at one end. A rod (1) in the rod structure is heavier than the other rods and points towards gravity. Furthermore, a roller (7) is positioned between the enclosure (8) and the plurality of rods. The roller (7) in the rod (1) is made of an opaque material to cast a shadow on the first and the second screen. The device enables indication of orientation of the object with simple construction.

### RELATED APPLICATIONS

The instant application is a 35 U.S.C. § 371 filing of International Patent Application No. PCT/IB2023/050047, filed Jan. 4, 2023, which claims priority to Indian Patent Application No. 202241000329, filed Jan. 4, 2022, the entire contents of which are incorporated herein by reference for all purposes.

### TECHNICAL FIELD

Present disclosure generally relates to the field of measuring devices. Particularly, but not exclusively, the present disclosure relates to a device for determination of orientation of surfaces or orientation of an object.

### BACKGROUND OF THE DISCLOSURE

Inertial measurements of an object are important in achieving stabilization of the object which is subjected to motion. Conventionally, an array of stabilization systems are used in order to provide stability to a moving object. One such stabilization means utilized in the art may include use of counterweights or counter forces to balance out unbalanced forces. However, such conventional means are futile, as large number of weights are to be used to balance the counter forces, thereby limiting the usage to only small-scale applications. With advancements in technology, devices such as but not limiting to gyroscopes, gimbal etc., are used in applications such as but not limiting to vehicles, ships, submarines, aircrafts and the like to determine the pitch, roll and yaw axes. This plays a role in orienting and positioning the vehicle/aircraft and also aids in maneuverability.

A gyroscope works on the principle of angular momentum which basically is the amount of rotation that an object may have, taking into account of mass and shape of the object. In simple words it is the vector quantity that represents the product of a body's rotational inertia and rotational velocity about a particular axis. Gyroscopes are of different types based on the different operating principles on which they adapt to.

Generally, gyroscopes such as the electronic, microchip-packaged MEMS gyroscope devices, solid-state ring lasers, fibre optic gyroscopes, and the extremely sensitive quantum gyroscope are known in the art. Their applications range from a variety of devices such as electronic gadgets to vehicles such as cars, ships and aircrafts. However, one of the major disadvantages of the gyroscope is its pan and tilt rotation speed. When the gyroscope is subjected to tilt and pan above the prescribed limit, the gyro fails to determine the orientation, this is seen in many of the electronic gadgets. However, not all gyroscopes and gimbals employed in electronic devices and vehicles have aforesaid disadvantages and ones without these flaws are expensive to manufacture. Secondly, the gyroscopes and gimbals have complex result obtaining techniques, and as already mentioned are very expensive to manufacture which is undesired.

Present disclosure is directed to overcome one or more limitations stated above or any other limitations associated with the known arts.

### SUMMARY OF THE DISCLOSURE

One or more shortcomings of the prior art are overcome by a device as claimed and additional advantages are provided through the device as claimed in the present disclosure. Additional features and advantages are realized through the techniques of the present disclosure. Other embodiments and aspects of the disclosure are described in detail herein and are considered a part of the claimed disclosure.

In one non-limiting embodiment a device for indicating orientation of an object is disclosed. The device includes a housing which is mounted on the object. The housing includes a first light source that is disposed on a first face of the housing and a second light source that is disposed on a second face of the housing. Further, the device includes a first screen which is disposed on a third face of the housing opposite to the first light source and a second screen which is disposed on a fourth face of the housing opposite to the second light source. Additionally, the device includes an enclosure that is disposed within the housing. A rod structure is rotatably disposed within the enclosure. The rod structure includes a plurality of rods that are fixed together at their one end. At least one rod of the plurality of rods is heavier than the other rods of the plurality of rods and is adapted to point towards gravity. Furthermore, at least one roller is positioned at a free end of each of the plurality of rods of the rod structure and displace within the enclosure. The at least one roller in the at least one rod of the plurality of rods is made of an opaque material to cast a shadow on the first screen and the second screen, to indicate orientation of the object. The configuration of the device enables indication and determination of the orientation of the object with simple construction which is inexpensive.

In an embodiment, the at least one roller which is positioned at the free end of each of the plurality of rods are equidistant from a center of the rod structure.

In an embodiment, each of the plurality of rods includes a provision at the free end to accommodate the at least one roller. The provision is defined with a hemispherical shape. This configuration enables free rotation of the rod structure.

In an embodiment, the enclosure is defined with a spherical shape and is made of at least one of a translucent material and a transparent material Further, the rod structure is also made of at least one a translucent material and a transparent material. This configuration of the enclosure and the rod structure allows light from the first and the second light source to pass through and incident on the first and second screen, respectively.

In an embodiment, the at least one roller is at least one of a ball bearing, a roller bearing, a journal bearings, a plain bearings, an acrylic bearing, a Polyvinyl chloride (PVC) bearings and a synthetic material bearing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiments when read in conjunction with the accompanying figures. One or more embodiments are now described, by way of example only, with reference to the accompanying figures wherein like reference numerals represent like elements and in which:

FIG. 1 illustrates a perspective view of a device for indicating orientation of an object, in accordance with an embodiment of the present disclosure.

FIG. 2a illustrates a schematic view of the device having a light beam emitted from a first light source and a second light source, in accordance with an embodiment of the present disclosure.

FIG. 2b illustrates a schematic view of the device of FIG. 2a, positioned on the object, which is oriented at an angle α with respect to horizontal, in accordance to an embodiment of the present disclosure.

FIG. 3 illustrates perspective view of the rod structure within an enclosure, in accordance with an embodiment of the present disclosure.

FIG. 4 illustrates perspective view of the rod structure within an enclosure, in accordance with an embodiment of the present disclosure.

FIGS. 5a and 5b illustrate top and bottom perspective views of the enclosure, in accordance with an embodiment of the present disclosure.

FIG. 6 illustrates perspective view of a rod structure of the device, in accordance with an embodiment of the present disclosure.

FIG. 7 illustrates perspective view of the rod structure of the device, in accordance with an embodiment of the present disclosure.

FIG. 8 illustrates perspective view of the device having the enclosure and the rod structure of FIG. 3, in accordance with an embodiment of the present disclosure.

FIG. 9 illustrates perspective view of the device having the enclosure and the rod structure of FIG. 4, in accordance with an embodiment of the present disclosure.

The figures depict embodiments of the disclosure for purposes of illustration only. One skilled in the art will readily recognize from the following description that alternative embodiments of the system and method illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that, the conception and specific embodiments disclosed may be readily utilized as a basis for modifying other brackets, devices, system, methods and processes for carrying out the same purposes of the present disclosure. It should also be realized by those skilled in the art that, such equivalent construction and method do not depart from the scope of the disclosure as set forth in the appended claims. The novel features which are believed to be characteristics of the disclosure, to its construction and features, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present document, the word “exemplary” is used herein to mean “serving as an example, instance, or illustration” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusions, such that a device or a system or a method that comprises a list of components or steps does not include only those components or steps but may include other components or steps not expressly listed or inherent to such device, system or method. In other words, one or more elements in a device or a system or a method proceeded by “comprises . . . a” does not, without more constraints, preclude the existence of other elements or additional elements in the device or system or method.

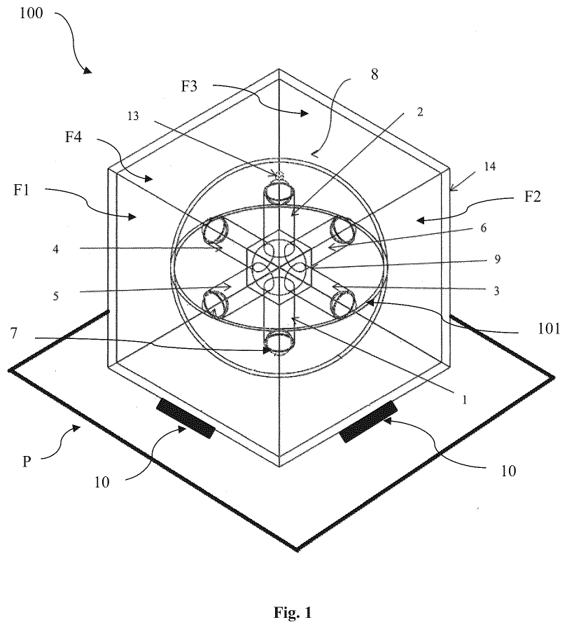

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-9.

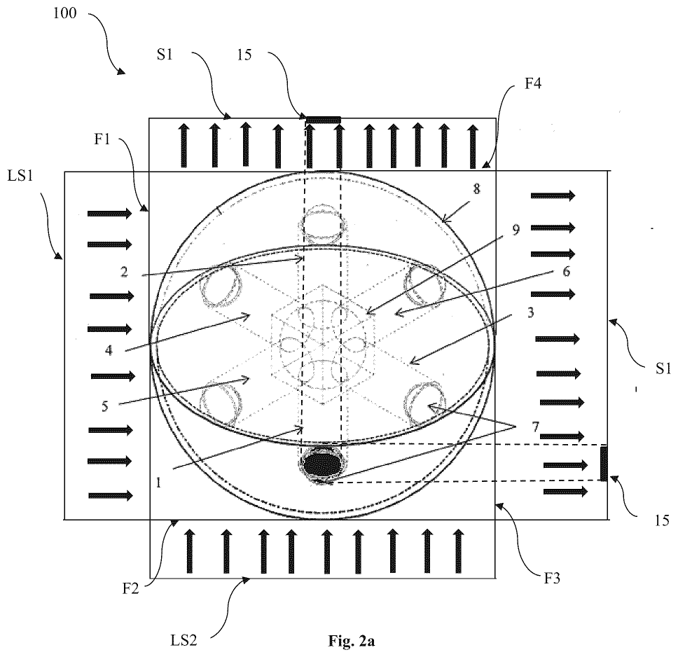

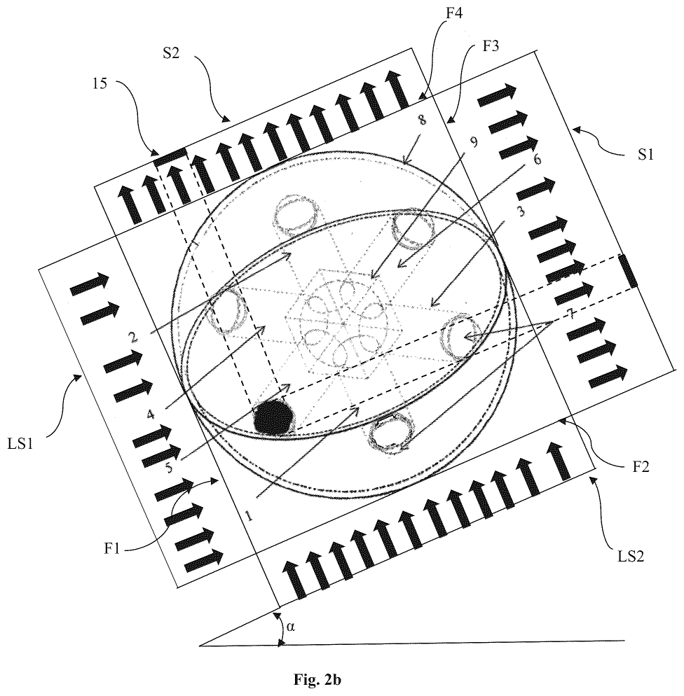

FIGS. 1 and 2a illustrates a perspective view of a device (100) for indicating orientation of an object (P). The device (100) may include a housing (14) positioned on the object (P). The housing (14) may be mounted on the object (P) or a surface of the object (P) for which the orientation has to be determined. In an embodiment, the device (100) may be configured to determine orientation of the object (P) along the three mutually perpendicular axes (pitch, roll and yaw) X, Y, Z axes. In an embodiment, the housing (14) may be mounted on the object (P) through plurality of mounting members (10). For example, the plurality of mounting members (10) may be including but not limited to a fastener, a slot, a groove, adhesive strips or may be mounted on the object (P) by permanent joining means such as welding and brazing. In an embodiment, the housing (14) may be defined with a shape including but not limiting to circular, square, rectangular, triangular, trapezoidal, octagonal, or any other shape which is generally known in the art.

The housing (14) may be defined with a plurality of faces. In an illustrated embodiment as seen in FIGS. 1 and 2a, the housing (14) is depicted having four faces, namely, a first face (F1), a second face (F2), a third face (F3) and a fourth face (F4). Further, the housing (14) may include a first light source (LS1) and a second light source (LS2) which may be provisioned on at least one face of the housing (14). In an exemplary embodiment, as seen in FIG. 2a, the first light source (LS1) may be disposed or connected to the first face (F1) of the housing (14). Further, the second light source (LS2) may be disposed or connected to the second face (F2) of the housing (14). Furthermore, the housing (14) may include a first screen (S1) and a second screen (S2). In an exemplary embodiment, the first screen (S1) may be disposed or connected to the third face (F3) of the housing (14) which may be opposite to the first face (F1). Additionally, the second screen (S2) may be disposed or connected to the fourth face (F4) of the housing (14) which may be opposite to the second face (F2).

In an embodiment, the first light source (LS1) and the second light source (LS2) may be at least one of but not limiting to a laser, incandescent bulb, light emitting diode and the like. It should be noted that the number of light sources and the number of screens should not be considered as a limitation as the device (100) may include more than one light source and more than one screen associated with an individual face of the housing (14).

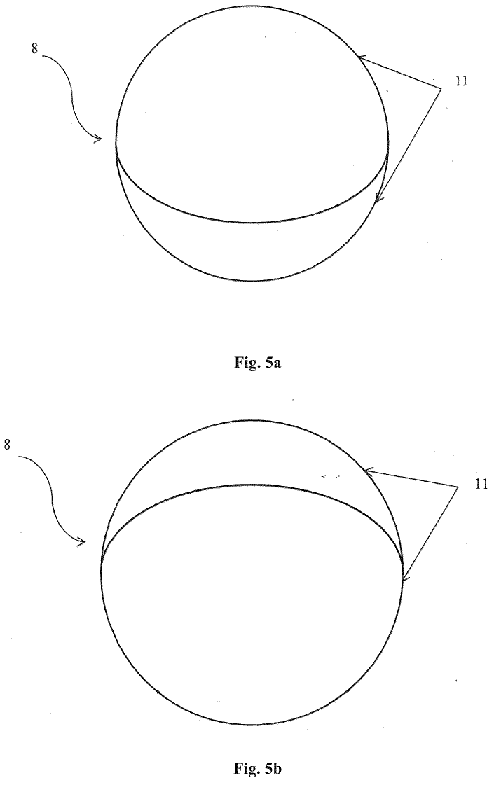

Referring now to FIGS. 1, 3 and 4, the device (100) may include an enclosure (8) which may be disposed within the housing (14). The enclosure (8) may be fixed to the inner surface of the housing (14) with the aid of a fixing arm (13) at one or more points. In an embodiment, the enclosure (8) may be fixed at least to a top face and a bottom face of the housing (14). In an exemplary embodiment of the present disclosure, as seen in FIGS. 5a and 5b, the enclosure (8) may be defined with a spherical shape. Further, the enclosure (8) may be formed by joining two half shell members (11). In an embodiment, the two half shell members (11) may be hemispherical in shape and may be joined either permanently or removably to form the spherical shaped enclosure (8). In an embodiment, the permanent joining methods such as but not limiting to thermal joining, and adhesive joining may be used to join the two half shell members (11). In alternative embodiment, removable joining methods such as threaded joining, snap fitting, and press fitting may be employed to join the two half shell members (11) to form the enclosure (8). Further, in an embodiment, the enclosure (8) may be made of a material including but not limiting to translucent or transparent material so as to allow light to pass through. For example, the enclosure may be made of a glass or a polymeric material which may be translucent or transparent material. This allows the light to travel from the first light source (LS1) and the second light source (LS2) towards the first screen (S1) and the second screen (S2) through the enclosure (8), respectively.

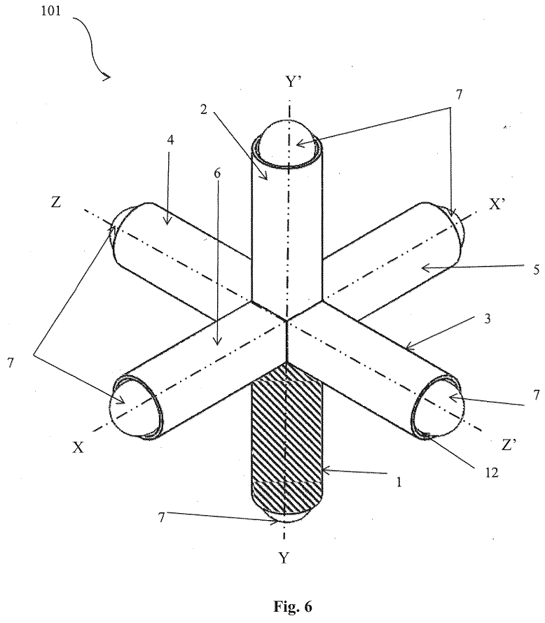

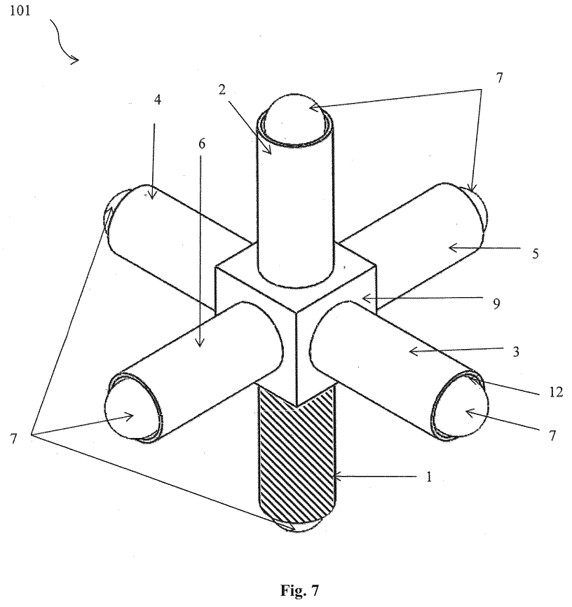

Furthermore, the device (100) may include a rod structure (101) [as seen in FIGS. 1, 3, 4, 6, 7] which may be disposed within the enclosure (8). The rod structure (101) may include plurality of rods (1, 2, 3, 4, 5, 6) which may be fixed or fused together at their one ends. That is, the plurality of rods (1, 2, 3, 4, 5, 6) fixed together may form a substantially perpendicular joint with the subsequent rod and may be substantially parallel to the rod which may be in same axis. Further, at least one rod (1) [hereafter referred to as heavier rod] out of the plurality of rods (1, 2, 3, 4, 5, 6) may be configured to be heavier than the other rods (2, 3, 4, 5, 6). The heavier rod (1) (for the purpose of illustration is hatched as shown in FIGS. 6 and 7) may be adapted to point towards gravity with respect to the other rods (2, 3, 4, 5, 6). In an embodiment, the heavier rod (1) may be made of a heavier material when compared to the material of the other rods (2, 3, 4, 5, 6). Further, the heavier rod (1) may be manufactured such that, the amount of material employed in the heavier rod (1) may be greater in volume or density than that of the volume or density of material used for manufacturing the other rods (2, 3, 4, 5, 6), thus making the heavier rod (1) orient itself towards gravity during operation. Each of the plurality of rods (1, 2, 3, 4, 5, 6) may be of equal lengths (L) in order to mitigate imbalance in forces acting on the rod structure (101) due to eccentricity developed at the center of gravity on the rod structure (101). Further, each of the plurality of rods (1, 2, 3, 4, 5, 6) may be configured in a shape including but, not limiting to circular, square, rectangular, triangular, trapezoidal, octagonal, or any other shape which may be generally known in the art. In an embodiment, the dimension of the plurality of rods (1, 2, 3, 4, 5, 6) may be equal. In an exemplary embodiment, the plurality of rods (1, 2, 3, 4, 5, 6) may be circular in shape and may have a diameter (D) which may be consistent with each of the plurality of rods (1, 2, 3, 4, 5, 6). The plurality of rods (1, 2, 3, 4, 5, 6) may be fused at their respective one ends in such a way that, the at least two rods may be parallel to at least one axis. As best shown in FIG. 6, the rods (1, 2) may be parallel to an X-axis (X-X′), the rods (3,4) may be parallel to Y-axis (Y-Y′), and the rods (5, 6) may be parallel to the Z-axis (Z-Z′). Additionally, each of the plurality of rods (1, 2, 3, 4, 5, 6) may be fused in such a way that, ends of each rod may be joined so as to form a star shaped structure with each of the rods pointing along X, Y and Z axes.

In an embodiment, the rod structure (101) and the each of the plurality of rods (1, 2, 3, 4, 5, 6) may be made of at least one of a transparent and a translucent material.

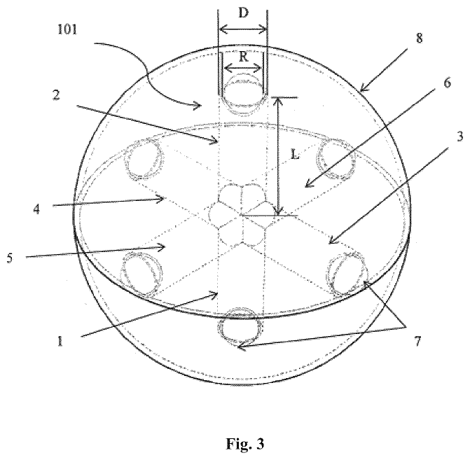

Further, each of the plurality of rods (1, 2, 3, 4, 5, 6) may be defined with a provision (12) at free ends. The provision (12) may be defined with a hemispherical shape. The provision (12) may be provided to accommodate at least one roller (7) for movement of the rod structure (101) within the enclosure (8) best shown in FIGS. 3 and 6. The at least one roller (7) may be defined with a spherical shape, and may be placed in such a way that, a portion of the at least one roller (7) may reside within the provision (12), and the remaining portion of the at least one roller (7) may protrude outside each of the plurality of rods (1, 2, 3, 4, 5, 6). In an embodiment, the at least one roller (7) may be positioned in-between an inner surface of the enclosure (8) and the provision (12) defined at the free ends of the plurality of rods (1, 2, 3, 4, 5, 6). The at least one roller (7) may be disposed in the provision (12) such that the at least one roller (7) may be free to rotate in any direction with respect to the force applied on the device (100). In an embodiment, the at least one roller (7) may be friction rollers which may rotate according to the direction of force applied on the device (100). In an embodiment, the at least one roller (7) may be selected from a group comprising but are not limited to, a ball bearing, a roller bearing, a journal bearings, a plain bearings, an acrylic bearing, a Polyvinyl chloride (PVC) bearings, a synthetic material bearing and any other specialized bearings capable of rotating between the plurality of rods (1, 2, 3, 4, 5, 6) and the inner surface of the enclosure (8). Further, diameter (R) of the at least one roller (7) may be smaller or larger than the diameter of the provision (12). In addition, the at least one roller (7) may be positioned within the provision (12) such that the center of each roller may be equidistant from the center of the rod structure (101).

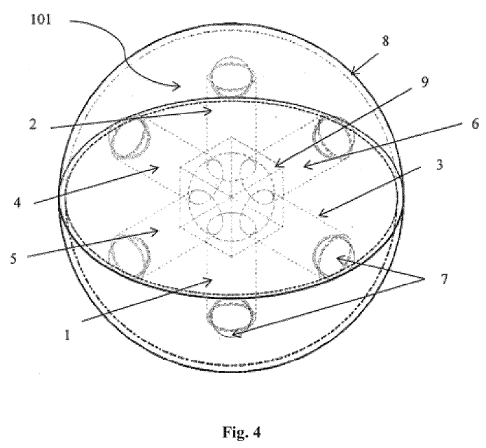

FIGS. 4 and 7, are another exemplary embodiment of the present disclosure which illustrate perspective view of the rod structure (101) having a cube structure (9). The rod structure (101) may be constructed in such a way that, one end of each of the plurality of rods (1, 2, 3, 4, 5, 6) may be fused to the center of at least one face of the cube structure (9). In an embodiment, by providing the cube structure (9) at the center of the rod structure (101) may aid in mitigating imbalances in the forces. Further, the cube structure (9) should not be considered as a limitation as the rod structure (101) may include any other shape or structure which may be defined at the one end of each of the plurality of rods (1, 2, 3, 4, 5, 6). For example, the rod structure (101) may include but not limited to a cube, a sphere or any other structure or shape which may aid in fusing the ends of each of the plurality of rods (1, 2, 3, 4, 5, 6) and facilitate in mitigating imbalance of forces.

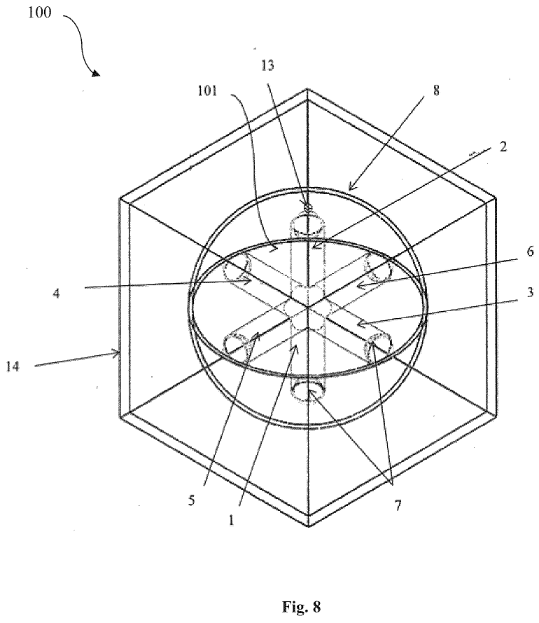

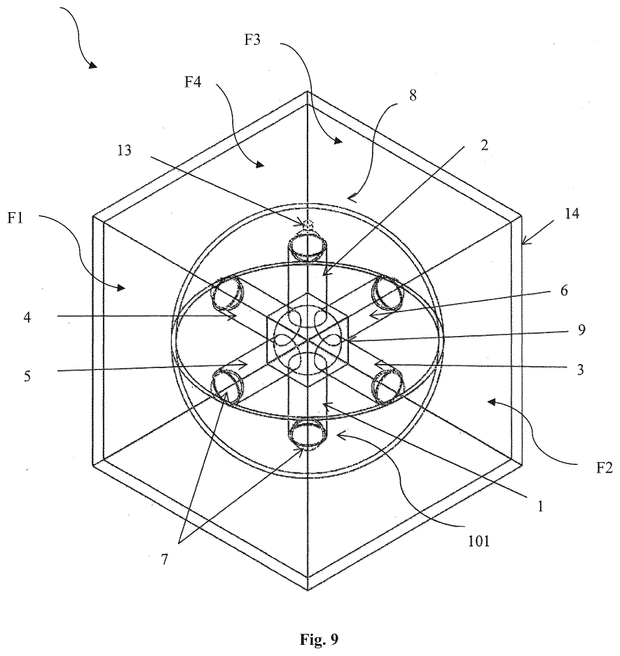

Further, as seen in FIGS. 3 and 4, the rod structure (101) may be enclosed in the enclosure (8) and may freely rotate within the enclosure (8) due to the force acting on the device (100), that is the directional/orientational changes of the housing (14) due to movement of the object (P). In an embodiment, the inner diameter of the enclosure (8) may be defined such that the rod structure (101) installed within the enclosure (8) rotates and orients itself with the help of the at least one roller (7). The at least one roller (7) may be in frictional contact with the inner surface of the enclosure (8) and rotate without any slippage. In an embodiment, the heavier rod (1) of the rod structure (101) may point towards gravity when the object (P) is under movement or displacement. In an embodiment, the object (P) may be inclined at an angle (α) with respect to the horizon. Even if the housing (14) may be inclined at an angle with respect to the object (P), the rod structure (101) having the heavier rod (1), may always point towards gravity [as seen in FIG. 2b]. Based on the directional forces applied on the object (P) the rod structure (101) may orient itself towards gravity due to the provision (12) of heavier rod (1) in comparison with the other rods (2, 3, 4, 5 and 6), thereby indicating the orientation of the object (P). Additionally, FIGS. 8 and 9 are an exemplary embodiments of the present disclosure which illustrates perspective view of the rod structures (101) of FIGS. 3 and 4, respectively. That is the housing (14) may include the rod structure (101) which may be defined without the cube structure (9) [as seen in FIG. 8] or with the cube structure (9) [as seen in FIG. 9].

In an embodiment, the rod structure (101) with the plurality of rods (1, 2, 3, 4, 5, 6) may be configured to point at X, Y and Z axes both in positive and negative coordinates upon being fixed to an inner surface of the housing (14).

In an embodiment, the heavier rod (1) of the plurality of rods (1, 2, 3, 4, 5, 6) may be made opaque and/or the at least one roller (7) positioned in the heavier rod (1) may be opaque to cast a shadow on the first screen (S1) and the second screen (S2). For illustrative purpose, as seen on FIGS. 2a and 2b, the at least one roller (7) positioned in the heavier rod (1) may be made opaque, however, the same should not be considered as a limitation as either the heavier rod (1) or the at least one roller (7) in the heavier rod (1) or both, may be made opaque to cast a shadow. It should be noted that even when the at least one roller (7) positioned in the heavier rod (1) is made opaque, the physical properties such as dimensions, shape, material used for manufacturing the at least one roller (7) in the heavier rod (1) may be identical to the at least one roller (7) positioned in each of the other rods (2, 3, 4, 5, 6) of the plurality of rods (1, 2, 3, 4, 5, 6) which ensures smooth and friction-less movement of the rod structure (101) inside the enclosure (8).

In an illustrative embodiment, as seen in FIGS. 2a and 2b, the at least one roller (7) associated with the heavier rod (1) may be made of an opaque material and the remaining at least one rollers (7) associated with the remaining rods (2, 3, 4, 5, 6) of the plurality of rods (1, 2, 3, 4, 5, 6) may be made transparent or a translucent material. Further, the first light source (LS1) and the second light source (LS2) may emit mutually perpendicular beams of light such that the beams of light may be incident on the enclosure (8). Additionally, the light beams emitted by the first light source (LS1) and the second light source (LS2) may have a diameter equal to or larger than that of the enclosure (8). Furthermore, the light beams may be incident on the spherical structure such that the diametrically opposite ends of the light beam may be incident tangentially on the diametrically opposite sides of the enclosure (8). The light beams emitted by the first light source (LS1) and the second light source (LS2) pass through the enclosure (8) and the rod structure (101) and impinge on the first screen (S1) and the second screen (S2), respectively. Upon the light beam emitted by the first light source (LS1) and the second light source (LS2), the at least one roller (7) in the heavier rod (1) of the plurality of rods (1, 2, 3, 4, 5, 6) which may be made of the opaque material may be adapted to cast the shadow on the first screen (S1) and the second screen (S2), to indicate orientation of the object (P) [as seen in FIG. 2a].

In an embodiment, the first screen (S1) and the second screen (S2) may be connected or may be associated with image capturing units or sensors that may configured detect light or variation in light. For example, the image capturing units or the sensors may be one of but not limiting to Charge-coupled devices CCD image sensor, optical sensors and Complementary metal-oxide-semiconductor (CMOS) sensor, optical camera and the like.

In an embodiment, the device (100) may be maintained in vacuum.

In an embodiment, the rod structure (101), the enclosure (8) and the housing (14) may be manufactured by additive manufacturing process. For example, the additive manufacturing may include but not limited to 3-D printing.

In an operational embodiment, when the object (P) may not be subjected to movement or displacement, the at least one roller (7) in the heavier rod (1) may be at the lowermost position of the inner surface of the enclosure (8). The light beams emitted by the first light source (LS1) and the second light source (LS2) impinge on the opaque roller (7) of the heavier rod (1) when passing through the enclosure (8), which results in formation of a shadow (15) or an image of the opaque roller (7) of the heavier rod on both the first screen (S1) and the second screen (S2) [as seen in FIG. 2a]. Further, as seen in FIG. 2b, which illustrates the device (100) positioned on the object (P) when the object/platform (200) is oriented at a certain angle (α) with respect to horizontal. For every angular rotation (about one or more axis) of the object (P) or the housing (14), the opaque roller (7) may occupy the lowermost position associated with the particular orientation of the object (P) or the housing (14), which may lead to casting of the shadow (15) or the image on the first screen (S1) and the second screen (S2). That is, the opaque roller (7) in the lower most position, may block impingement of light from first light source (LS1) and the second light source (LS2) on to a portion of the first screen (S1) and the second screen (S2), respectively thereby casting shadow (15) at portion of the first screen (S1) and the second screen (S2). In an embodiment, lowermost position of the opaque roller (7) within the enclosure (8) may continuously vary based on the orientation of the object. The pair of shadows (15) or the image may be read by the image capturing units or sensors associated with the first screen (S1) and the second screen (S2) which may then be translated into digital signals. The digital signals can be programmed to read as that particular orientation's inclination about the pitch, roll and yaw axis of the object (P). In an embodiment, the device (100) may be coupled to a control unit [not shown] which may receive the digital signals from the sensors to determine the position of the object (P).

In an embodiment, the device (100) may be connected to an external power source or may be connected to a portable power source positioned within the device (100).

In an embodiment, the orientation determination of a particular object (P) can be determined by the device (100) provisioned with at least one or combination of the following but not limiting to analog markings, use of sensors or any other similar orientation measuring techniques which are known in the art.

In an embodiment, the device (100) is simple to construct and manufacture. Further, as the light source (LS1 and LS2) and the screens (S1 and S2) are provisioned outside the enclosure (8), maintenance of the device (100) is simple and may not require dismantling the whole device (100).

Additionally, the device (100) facilitates easy and simple determination or indication of the orientation of the object (P).

It should be noted that in an exemplary embodiment, as seen in the FIGS. 1-9 the features, construction, position and connections should not be construed as a limitation as the device (100) may include any other type of features, construction, position, and connections which may work with other combinations for indicating orientation of the object (P).

It should be imperative that the device and any other elements described in the above detailed description should not be considered as a limitation with respect to the figures. Rather, variation to such system and method should be considered within the scope of the detailed description.

### Equivalents

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope.

Referral Numerals:

| Reference Number | Description |
|---|---|
| 100 | Device |
| 101 | Rod structure |
| 1, 2, 3, 4, 5, 6 | Rods |
| 7 | Roller |
| 8 | Enclosure |
| 9 | Cube structure |
| 10 | Mounting member |
| 11 | Half shell member |
| 12 | Provision |
| 13 | Fixing arm |
| 14 | Housing |
| 15 | Shadow |
| P | Object |
| L | Length of rod |
| D | Diameter of rod |
| R | Diameter of roller |
| LS1 | First light source |
| LS2 | Second light source |
| F1 | First face |
| F2 | Second face |
| F3 | Third face |
| F4 | Fourth face |
| S1 | First screen |
| S2 | Second screen |

1. A device (100) for indicating orientation of an object (P), the device (100) comprising:
a housing (14) mountable on the object (P), the housing (14) comprises:
a first light source (LS1) disposed on a first face (F1) of the housing (14);
a second light source (LS2) disposed on a second face (F2) of the housing (14);
a first screen (S1) disposed on a third face (F3) of the housing (14), opposite to the first light source (LS1); and
a second screen (S2) disposed on a fourth face (F4) of the housing (14) opposite to the second light source (LS2);
an enclosure (8) disposed within the housing (14);
a rod structure (101) rotatably disposed within the enclosure (8), the rod structure (101) comprises a plurality of rods (1, 2, 3, 4, 5, 6) fixed together at their one end, wherein at least one rod (1) of the plurality of rods (1, 2, 3, 4, 5, 6) is heavier than the other rods (2, 3, 4, 5, 6) of the plurality of rods (1, 2, 3, 4, 5, 6) and is adapted to point towards gravity; and
at least one roller (7) is positioned at a free end of each of the plurality of rods (1, 2, 3, 4, 5, 6) of the rod structure (101) and displace within the enclosure, wherein, the at least one roller (7) in the at least one rod (1) of the plurality of rods (1, 2, 3, 4, 5, 6) is made of an opaque material to cast a shadow (15) on the first screen (S1) and the second screen (S2), to indicate orientation of the object (P).

2. The device (100) as claimed in claim 1, wherein the at least one roller (7) positioned at the free end of each of the plurality of rods (1, 2, 3, 4, 5, 6) are equidistant from a center of the rod structure (101).

3. The device (100) as claimed in claim 1, wherein each of the plurality of rods (1, 2, 3, 4, 5, 6) comprises a provision (12) at the free end to accommodate the at least one roller (7).

4. The device (100) as claimed in claim 3, wherein the provision (12) is defined with a hemispherical shape.

5. The device (100) as claimed in claim 1, wherein the enclosure (8) is defined with a spherical shape.

6. The device (100) as claimed in claim 1, wherein the enclosure (8) is made of at least one of a translucent material and a transparent material.

7. The device (100) as claimed in claim 1, wherein the rod structure (101) is made of at least one a translucent material and a transparent material.

8. The device (100) as claimed in claim 1, wherein the at least one roller (7) is at least one of a ball bearing, a roller bearing, a journal bearings, a plain bearings, an acrylic bearing, a Polyvinyl chloride (PVC) bearings and a synthetic material bearing.
